(19) United States
(12) Patent Application Publication
(10) Pub. No.: US 2026/0340934 A1
(43) Pub. Date: Oct. 29, 2026

(54) METHODS AND SYSTEMS FOR VALIDATING RECOVERY OF IMAGE INFORMATION

(71) Applicant: Accenture Global Solutions Limited, Dublin (IE)

(72) Inventors: Howard James Jarrell BRAND, Charlotte, NC (US); Marc BOSCH RUIZ, Arlington, VA (US); Kyle Patrick O'BRIEN, One Manhattan West, Corp, NY (US)

(73) Assignee: Accenture Global Solutions Limited, Dublin (IE)

(21) Appl. No.: 19/190,069

(22) Filed: Apr. 25, 2025

(51) Int. Cl. G06T 15/20; G06T 7/00

(52) U.S. Cl. CPC G06T 15/205; G06T 7/0002; G06T 2207/20081; G06T 2207/30168

(57) ABSTRACT

Method, system, and computer-readable storage media for validating recovery of actionable information in an image are disclosed. A first image is received and a splatted image corresponding to the first image is generated by performing a smearing process on a padded image of the first image based on selection of a 2D Gaussian kernel from a precomputed Gaussian dictionary. The splatted image is used to train a confidence model to compute a distance value and the distance value is compared with a ground-truth distance value. Based on the comparison, the confidence model is iteratively trained to generate a trained confidence model. A second image including uncertainty artifacts is received and a distance value for the second image is determined using the trained confidence model. The distance value is used to determine a confidence score for the second image that validates recovery of the actionable information in the second image.

### GOVERNMENT RIGHTS

This invention was made with government support under contract number 140D 0423C 0035 awarded by the Intelligence Advanced Research Projects Activity (IARPA) via Department of Interior/Interior Business Center (DOI/IBC). The government has certain rights in the invention.

### TECHNICAL FIELD

Various examples described herein relate generally to method, system, and computer program product for validating recovery of actionable information in an image including uncertainty artifacts.

### BACKGROUND

Novel view rendering image systems have recently seen an explosion in popularity due to their abilities in generating images of a scene from different viewpoints (e.g., novel viewpoints) that have not been captured in an original image of the scene. Therefore, the novel view rendering image systems may aid in recovering unexplored regions of the original image using the images generated from the different viewpoints (e.g., neighboring observations).

The novel view rendering image systems may use various Artificial Intelligence (AI) or Machine Learning (ML) models to generate the images of the scene from the different viewpoints by learning various attributes (e.g., a geometry, appearance, a color, and/or the like) associated with the scene. One of the various AI or ML models includes a three-dimensional (3D) Gaussian Splatting (3DGS) model. The 3DGS model represents the scene as a set of 3D Gaussians, which may be efficiently rendered from the different viewpoints.

### SUMMARY

In at least one example, the present disclosure provides a computer-implemented method for generating and validating splatted images. The method includes receiving a first image and generating a padded image by padding the received first image. The padded image is generated according to a particular size of a two-dimensional (2D) Gaussian kernel, and the particular size is a maximum size of the 2D Gaussian kernel. The method includes selecting a minimum size of the 2D Gaussian kernel and the maximum size of the 2D Gaussian kernel. The method includes randomly sampling one or more pixels of the padded image. The method includes generating a splatted image by performing a smearing process on the padded image at the one or more randomly sampled pixels starting with the minimum size of the 2D Gaussian kernel and ending with the maximum size of the 2D Gaussian kernel.

In some examples, the method further includes generating and concatenating first feature vectors corresponding to the splatted image. The first feature vectors are generated by processing the splatted image using a first encoder and a second encoder. The method includes converting the first feature vectors into second feature vectors using an average pooling function. The method includes generating a distance value corresponding to the second feature vectors using a confidence model. The method includes comparing the distance value corresponding to the second feature vectors with a ground-truth distance value. The ground-truth distance value is computed between a ground-truth image and the splatted image using a distance value generation model. The method includes generating a trained confidence model by updating the confidence model based on the comparison.

In some examples, the method further includes receiving a second image and determining a distance value for the second image using the trained confidence model. The method includes determining a confidence score for the second image based on the generated distance value for the second image.

The present disclosure further describes a system for implementing the method provided herein. The present disclosure also describes a non-transitory computer-readable storage media (CRM) having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment used to execute implementations of the present disclosure.

FIG. 2 depicts an example conceptual architecture of an artifact emulation engine of a system disclosed in the example environment of FIG. 1, in accordance with implementations of the present disclosure.

FIG. 3 depicts an example process flow of generating a pixel quantity list by the artifact emulation engine, in accordance with implementations of the present disclosure.

FIG. 4A depicts an example process flow of generating a splatted image by the artifact emulation engine, in accordance with implementations of the present disclosure.

FIG. 4B depicts an example pseudo code describing smearing of padded image using a smear coordinate list, in accordance with implementations of the present disclosure.

FIG. 5 depicts an example illustration of generating the splatted image by performing a smearing process, in accordance with implementations of the present disclosure.

FIG. 6A depicts an example illustration of a precomputed Gaussian dictionary, in accordance with implementations of the present disclosure.

FIG. 6B depicts an example illustration of a first image, in accordance with implementations of the present disclosure.

FIG. 6C depicts an example illustration of the first image with a complete set of pixels, in accordance with implementations of the present disclosure.

FIG. 6D depicts an example illustration of a padded image, in accordance with implementations of the present disclosure.

FIG. 6E depicts an example illustration of splatted images with different uncertainty artifacts, in accordance with implementations of the present disclosure.

FIG. 7A depicts an example conceptual architecture of a confidence validation engine of the system disclosed in the example environment of FIG. 1, for training a confidence model, in accordance with implementations of the present disclosure.

FIG. 7B depicts another example conceptual architecture of the confidence validation engine of the system, for validating recovery of actionable information in a second image using a trained confidence model, in accordance with implementations of the present disclosure.

FIG. 8A depicts an example illustration of second images with high confidence scores, in accordance with implementations of the present disclosure.

FIG. 8B depicts an example illustration of second images with low confidence scores, in accordance with implementations of the present disclosure.

FIG. 9 is a flow diagram that presents an example computer implemented method for generating the splatted image corresponding to the first image, in accordance with implementations of the present disclosure.

FIG. 10 is a flow diagram that presents an example computer implemented method for generating the trained confidence model and using the trained confidence model for validating recovery of the actionable information in the second image, in accordance with implementations of the present disclosure.

FIG. 11 depicts an example computer system to implement the system disclosed in the example environment of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality or acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Actionable information,” “human visual information,” “image information,” and/or the like, may refer to distribution of objects, actors, environmental settings, and/or the like, in an image of a scene.

“Uncertainty artifacts,” “smearing artifacts,” “splatting artifacts,” and/or the like, may refer to visual inconsistencies or unnecessary features present in an image, wherein the visual inconsistencies or unnecessary features are generated using Gaussian splatting. Non-limiting examples of the visual inconsistencies or unnecessary features present in the image may include blurry regions, floaters, sharpened edges or outlines, artificial edges, fog effects, over-reconstruction of features, and/or the like.

“First image,” and/or the like, may refer to an image of a scene without including any uncertainty artifacts. In some examples, the first image may include an original, or an ideal, or a ground-truth image including only the actionable information of the scene. In some other examples, the first image may include any available image of the scene without including any uncertainty artifacts or an image generated using an available dataset associated with the scene. In some other examples, the first image may include a two-dimensional (2D) rendered image using a three-dimensional Gaussian Splatting (3DGS) model.

“Padded image,” and/or the like, may refer to the first image with additional pixels.

“Splatted image,” and/or the like, may refer to an emulated or simulated or augmented image from the first image and may be injected with the uncertainty artifacts at different levels. The splatted image may be used for training of a confidence model.

“Two-dimensional (2D) Gaussian kernel,” and/or the like, may refer to a 2D array representing a Gaussian distribution function, which may be used in a smearing process.

“Window sizes,” “kernel levels,” “kernel sizes,” and/or the like, may refer to areas or regions for distribution of 2D Gaussian kernels.

“Perturbing” and/or the like, may refer to a process of altering or modifying a color of the 2D Gaussian kernel.

“Smearing process,” “layered 2D Gaussian splatting,” and/or the like, may refer to a process or method used for generating the splatted image by injecting the uncertainty artifacts into the padded image corresponding to the first image.

“Second image,” “input image,” and/or the like, may refer to an image to be validated in real-time for evaluating a confidence level associated with recovery of the actionable information in the image in presence of the uncertainty artifacts.

“Confidence model,” “Multi-Layer Perceptron (MPL) model,” and/or the like, may refer to any Artificial Intelligence (AI) or Machine Learning (ML) or Generative AI model, which may be trained for validating recovery of the actionable information in the second image.

“Confidence score” and/or the like, may refer to a score that identifies a confidence level associated with recovery of the actionable information in the second image.

Various applications (e.g., mission planning applications, human assistance applications, disaster recovery applications, and/or the like) may require generation of images of a scene or site from different viewpoints, so that regions or areas of the scene or site may be explored. Such applications may use an existing novel view rendering image system for generating the images. The existing novel view rendering image system may use a three-dimensional (3D) Gaussian Splatting (3DGS) model for generating the images of the scene from the different viewpoints. The 3DGS model may explicitly model a geometry, a color, and/or the like, of the scene with a set of 3D Gaussians (e.g., also be referenced as Gaussian splats, semi-transparent blobs, and/or the like). Each Gaussian in the set of 3D Gaussians may have their own color and uncertainties values. Once the set of 3D Gaussians are obtained, the images may be generated and rendered via an image projection of the set of 3D Gaussians in accordance with a relative position and orientation, and a model of a camera being used for capturing the scene. Generation and rendering of the images via the image projection of the set of 3D Gaussians may result in two-dimensional (2D) Gaussian kernels at each pixel in each of the images. The 2D Gaussian kernels may impose uncertainty artifacts on the images based on uncertainties resultant from the 2D Gaussian kernels and a proximity to the camera. Therefore, the images generated using the 3DGS model may include actionable information along with the uncertainty artifacts. The actionable information may be used to explore one or more regions of interest in the scene, which may enable human situational awareness towards the scene without a need for explicit manual investigation.

In addition to generation of the images, validation of the generated images may provide a confidence level for the human situation awareness. For example, validation of the generated images may involve validating a quality of the generated images by evaluating success in recovery or recognizability of actionable information (e.g., distribution of objects, actors, environmental settings, and/or the like) from the generated images. Therefore, from the validation, a user may decide whether to use the recovered actionable information for various purposes according to the respective applications.

In some examples, the existing novel view rendering image system may employ a validation framework including an Artificial Intelligence (AI) model for performing the validation of the generated images. However, the validation framework may perform the validation by performing difference measurements based on pixel values of the generated images rather than considering the uncertainty artifacts. Further, the validation framework may fail to receive any ground-truth images corresponding to the generated images for evaluating. Therefore, the validation framework may fail to efficiently determine what actionable information (e.g., objects, actors, and/or the like) are retained or conserved in the generated images from the different viewpoints. In addition, the validation framework may fail to perform the validation of the generated image by considering the presence of the uncertainty artifacts in the generated images due to the following limitations.

Data with the uncertainty artifacts may be required for training the AI model to perform the validation of the generated images. However, the data with the uncertainty artifacts may include a limited set of observations and may be expensive to obtain. Further, it may be difficult for the existing novel view rendering image system to generate the data including all the uncertainty artifacts specifically at quantity and variation required for facilitating training of the AI model.

Further, it may be expensive for the validation framework to train the AI model with the data including the uncertainty artifacts. Therefore, the validation framework employed by the existing novel view rendering image system may be at a low-level to assess or evaluate a success in recovery or recognizability of high-level actionable information in the generated images.

With the above-described limitations, the existing novel view rendering image system may expend significant amount of time, cost, and computing resources for validating the images, which may further fail to validate successful recovery of the actionable information due to the uncertainty artifacts.

Implementations of the present disclosure provide an AI framework or pipeline that improves accuracy or success in recovery of the actionable information in the images, while addressing limitations of the existing novel view rendering image system. The AI framework may include an emulation framework and a confidence assessment framework.

The emulation framework may generate splatted images by generating 2D Gaussian kernels of random uncertainties and sizes. The 2D Gaussian kernels may identify emulated or simulated uncertainty artifacts at multiple scales from potentially resulting image projections of the 3DGS model of the scene that appears as 2D Gaussians on an image plane. Therefore, the emulation framework may generate or impose a wide variety of the uncertainty artifacts that may be required for successfully recovering the actionable information in the images of the scene and that may allow capturing of novel view points of the scene that has no ground truth to be recovered with reduced uncertainties. At different stages of training, the 2D Gaussian kernels may have different levels of uncertainty artifacts. In addition, the emulation framework may use a precomputed Gaussian dictionary to improve speed of generating the uncertainty artifacts, which may further enable the confidence assessment framework to use the uncertainty artifacts with any available training datasets for training a confidence model, without a need for preparing or prebuilding new training datasets.

The confidence assessment framework may operate in conjunction with the emulation framework to train the confidence model for validating images in real-time. The validation of images may include assessing or evaluating a confidence level associated with a recovery of the actionable information in the images. The confidence assessment framework may train the confidence model to generate a confidence score for each of the images by combining non-reference image quality assessment descriptors and the actionable information recovered from each of the images. Along with evaluation of the confidence level associated with the recovery of the actionable information, the confidence assessment framework may also train the confidence model to assess or evaluate a confidence level associated with generation of a number of types of the uncertainty artifacts and a quality of each of the non-reference image quality descriptors.

While implementations of the present disclosure are realized by considering the emulation framework and the confidence assessment framework for recovery and validating the actionable information based on the confidence score, it is contemplated that implementations of the present disclosure may be realized for one or more novel view image recovery tasks such as removing or mitigating the uncertainty artifacts, and may adapt the AI pipeline for other high-level tasks such as object recognition and localization.

Further, implementations of the present disclosure are described by considering generation of uncertainty artifacts or smearing artifacts using Gaussian splatting techniques and validation of images generated using Gaussian splatting techniques, however it is contemplated that images may be generated using any other similar models or techniques such as Gen AI models, ML models, AI models, and/or the like, and may be associated with uncertainty artifacts other than the uncertainty artifacts or smearing artifacts generated using Gaussian splatting techniques.

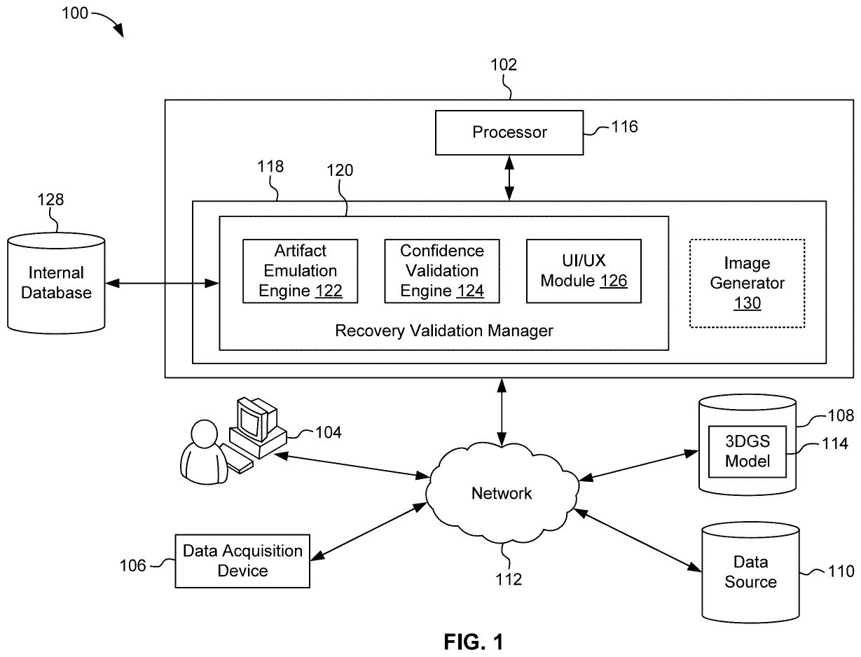

FIG. 1 depicts an example environment 100 used to execute implementations of the present disclosure. The example environment 100, depicted in FIG. 1, includes a system 102 (also be referenced as a recovery and confidence assessment system, a novel view rendering image system, a computing device, and/or the like), a user device 104, a data acquisition device 106, a model database 108, and a data source 110. For simplicity, a single user device, a single data acquisition device, and a single data source is depicted in FIG. 1, however as would be understood the example environment 100 may include multiple user devices, multiple data acquisition devices, and multiple data sources. In some examples, the system 102 may include the user device 104 and the data acquisition device 106. The system 102 may communicate with the user device 104, the data acquisition device 106, the model database 108, and the data source 110 using a network 112. In some examples, the network 112 may include a Local Area Network (LAN), a Wide Area Network (WAN), the Internet, or a combination thereof. In some examples, the network may be accessed over a wired and/or a wireless communication link.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

In some examples, the system 102 may be implemented as an on-premises system that is operated by an enterprise or a third-party engaged in cross-platform interactions and information management. In some other examples, the system 102 may be implemented as an off-premises system (for example, cloud or on-demand) that is operated by the enterprise or the third-party on behalf of the enterprise. In some other examples, the system 102 may be implemented in a cloud environment. For simplicity, the system 102 depicted in FIG. 1 may be a cloud-based system that is intended to represent various forms of servers including a web server, an application server, a proxy server, a network server, a server pool, and/or the like.

The system 102 may be used in various applications such as, but are not limited to, real-time image rendering applications, human assistance applications, disaster recovery applications, mission planning applications, robotics and autonomous navigation, image recovery applications, or any other applications that require analysis of images of scenes or sites from different viewpoints. While implementations of the present disclosure are realized by considering the images, it is contemplated that implementations of the present disclosure may be realized with a set of images including sequenced (e.g., videos) or non-sequenced.

In an implementation, the system 102 may receive a request including images of scenes from the user device 104 and/or the data acquisition device 106 and accordingly validate recovery of actionable information in the images (also be referenced as image validation). The user device 104 may be associated with a user (e.g., an administrator, and/or an entity (e.g., an enterprise, an organization, and/or the like). Non-limiting examples of the user device 104 may include a desktop, smartphones, laptops, a tablet, and/or the like. The user device 104 may present one or more user interfaces (e.g., Graphical User Interfaces (GUIs)) of a workspace for the user to interact with the system 102. The data acquisition device 106 may include any device that is being capable of capturing and/or generating the input images and storing the input images. Non-limiting examples of the data acquisition device 106 may include a multi-camera system, a video camera, a camera, and/or the like.

In another implementation, the system 102 may generate the images of the scenes from different viewpoints (e.g., novel viewpoints) and validate the recovery of the actionable information in the generated images. The images may be generated using a 3D Gaussian splatting (3DGS) model 114 (or any other Gaussian splatting model) stored in the model database 108. Components of the system 102 are described in detail below.

As depicted in FIG. 1, the system 102 includes a processor 116 and a memory 118 communicably coupled to the processor 116. The processor 116 may include one or more processors. Examples of the processor 116 may include, but are not limited to, microprocessors, microcomputers, microcontrollers, digital signal processors, central processing units, state machines, logic circuits, and/or any devices that manipulate data or signals based on operational instructions. Among other capabilities, the processor 116 may fetch instructions (also be referenced to as processor-executable instructions or machine-executable instructions) from the memory 118 and execute the fetched instructions for performing operations (e.g., image validation) according to the present disclosure. The memory 118 may be non-volatile or non-transitory computer-readable medium (CRM) such as, a magnetic disk or solid-state non-volatile memory or volatile medium such as Random Access Memory (RAM), and/or the like. Further, the system 102 includes a recovery validation manager 120. The recovery validation manager 120 may be stored in the memory 118 and provided as a downloadable library including the instructions. The recovery validation manager 120 includes an artifact emulation engine 122 (also be referenced as a novel view image artifact emulator, an emulation framework, and/or the like), a confidence validation engine 124 (also be referenced as a confidence framework, a human visual information confidence assessment or validation engine, and/or the like), and a User Interface (UI)/User Experience (UX) module 126. Further, the recovery validation manager 120 may be communicatively coupled to an internal database 128, which may store various data and intermediate results generated by the artifact emulation engine 122, the confidence validation engine 124, and the UI/UX module 126.

### Training Phase:

In an example implementation, the processor 116 may execute the artifact emulation engine 122 to receive first images and generate splatted images corresponding to the received first images. In some examples, the first images may be received from the data source 110 that include original images or ground-truth images of different scenes that have been captured from different devices (e.g., data acquisition devices). In some other examples, the first images may include two-dimensional (2D) renders of the 3DGS model 114. The first images may include only the actionable information without uncertainty artifacts. The splatted images may include emulated or simulated first images including the actionable information along with the uncertainty artifacts. The actionable information (also be referenced as human visual information) may include distribution of objects, actors, environmental settings, and/or the like. The uncertainty artifacts (also be referenced as smearing artifacts, splatting artifacts, ghosting effects, and/or the like) may indicate visual inconsistencies or unnecessary features in the images. Non-limiting examples of the uncertainty artifacts may include blurry regions, floaters, sharpened edges or outlines, artificial edges, fog effects, over-reconstruction of features, and/or the like.

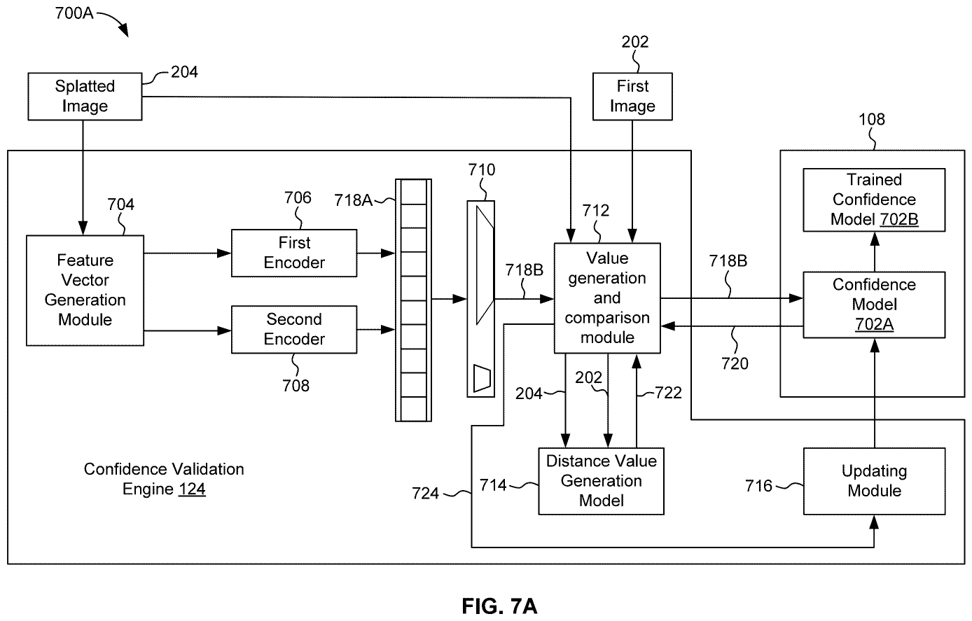

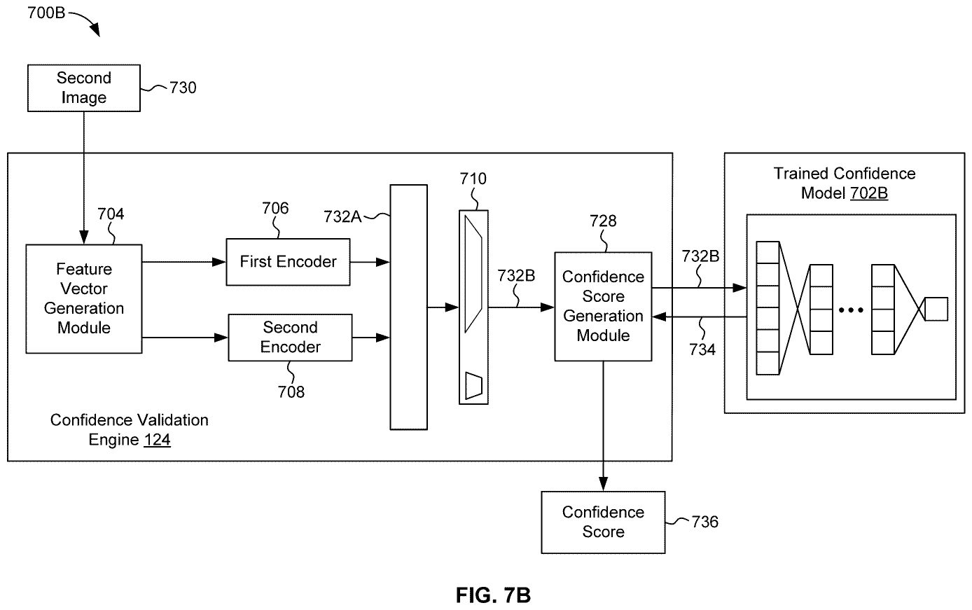

In an example implementation, the processor 116 may execute the confidence validation engine 124 to train a confidence model (depicted in FIG. 7A) based on the generated splatted images corresponding to the first images.

### Inference Phase:

In an example implementation, the processor 116 may execute the UI/UX module 126 to receive second images of scene(s) from the user device 104 and/or the data acquisition device 106 and a request for validating the second images. The second images of the scene(s) may include the actionable information along with the uncertainty artifacts. Optionally, the system 102 may include an image generator 130, which may be executed by the processor 116 to generate the second images using the 3DGS model 114 (or any other Gaussian splatting techniques).

In an example implementation, the processor 116 may execute the confidence validation engine 124 to use the trained confidence model (depicted in FIGS. 7A and 7B) for validating recovery of the actionable information in each of the second images by considering the uncertainty artifacts present in the second images. Further, the processor 116 may execute the UI/UX module 126 to provide results of validating the recovery of the actionable information in each of the second images on the user device 104 and/or the data acquisition device 106.

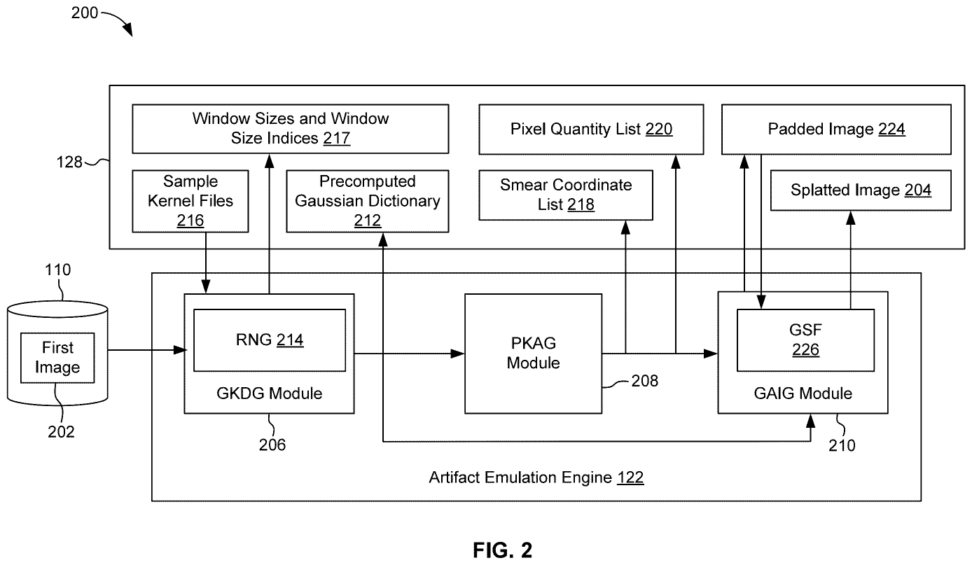

Various examples of validating the recovery of the actionable information in the second images are described in detail in conjunction with FIGS. 2-11.

FIG. 2 depicts an example conceptual architecture 200 of the artifact emulation engine 122 of the system 102 disclosed in the example environment 100 of FIG. 1, in accordance with implementations of the present disclosure. The artifact emulation engine 122 may receive a first image 202 from the data source 110 and generate a splatted image 204 corresponding to the first image 202 by injecting the uncertainty artifacts into the first image 202. The artifact emulation engine 122, depicted in FIG. 2, includes a Gaussian Kernel Dictionary Generation (GKDG) module 206, a Pixel and Kernel Assignment Generation (PKAG) module 208, and a Gaussian Artifact Image Generation (GAIG) module 210.

The GKDG module 206 may generate a precomputed Gaussian dictionary 212. The precomputed Gaussian dictionary 212 includes two-dimensional (2D) Gaussian kernels. A 2D Gaussian kernel may include a filter or function that may be used for injecting the uncertainty artifacts into the first image 202. The 2D Gaussian kernels may be of different sizes and random uncertainties. For example, the 2D Gaussian kernels may include a 2D Gaussian kernel with a minimum size and a 2D Gaussian kernel with a maximum size. By way of non-limiting example, the minimum size may include 20 and the maximum size may include 180, which may further result in 20×20 kernels and 180×180 kernels, respectively.

In some examples, the GKDG module 206 may use a Random Number Generator (RNG) 214 for generating the precomputed Gaussian dictionary 212 including the 2D Gaussian kernels. To illustrate in detail, the RNG 214 may select a window size (also be referenced as kernel level, kernel size, and/or the like) for generating the 2D Gaussian kernels. The window size may indicate an area or region for distribution of the 2D Gaussian kernels. The window size may include a number of window sizes or an array of window sizes. In some examples, the RNG 214 may select the window size based on the type of uncertainty artifacts (e.g., blur, smoothing effects, contrast change, and/or the like) to be injected into the first image 202. In some other examples, the RING 214 may select the window size randomly. The RNG 214 may store the selected window size including the number of window sizes and corresponding window size indices 217 in the internal database 128.

Based on the selected window size, the RNG 214 may compute a covariance matrix. A size of the covariance matrix may be defined by the selected window size. For example, if the window size indicates a size of ‘s×s,’ then the covariance matrix includes a ‘s’ number of rows and a ‘s’ number of columns. By way of non-limiting example, if the RNG 214 selects the window size of 2×2, the RNG 214 may compute the covariance matrix including 2 rows and 2 columns. The covariance matrix may indicate a spread (e.g., variance) and orientation (e.g., correlation) between distribution of the 2D Gaussian kernels.

Once the covariance matrix is computed based on the selected window size, the RNG 214 may identify and access sample kernel files 216 from the internal database 128. The sample kernel files 216 may include sample 2D Gaussian kernels matching the selected window size. Each of the sample kernel files 216 may be stored in standard file format, for example, a binary file format. By way of non-limiting example, the binary file format may include ‘npy’ format. Further, each of the sample kernel files 216 may include an array of size ‘s×s×mₙ,’ where ‘s×S’ may indicate the window size and ‘mₙ’ may indicate a number of sample 2D kernels corresponding to a window size index ‘kₙ.’ Once the sample kernel files 216 are identified and accessed, the RNG 214 may append the sample 2D Gaussian kernels in each of the sample kernel files 216 into a list from smallest to largest window size using the covariance matrix, thereby generating a list of random 2D Gaussian kernels. In an example, the list of random 2D Gaussian kernels may be generated using the covariance matrix as:

$${g}_{d} ( {k}_{n} ) = \frac{1}{2 \vert \sqrt{{( 2 π )}^{2} \sum } \vert} {e}^{- i ( \frac{1}{2} ) {x ( {k}_{n} )}^{T} {\sum }^{- 1} x ( {k}_{n} )}$$

wherein, (i) g_{d}(kₙ) may indicate the list of random 2D Gaussian kernels based on the window size index ‘kₙ,’ (ii) the window size index kₙ=[0, 1, . . . , N−1], where ‘N’ may indicate a number of window sizes; (iii) Σ=RR^{T}+0.025*I, where R=RNG ([.]_{2×2})] and ‘[.]_{2×2}’ may indicate the covariance matrix; (vi) s=size_window_list[kₙ]; and (v) x(kₙ)=mesh grid (L, L), whereL=line space (2.5, 2.5, s).

Upon generating the list of random 2D Gaussian kernels, the RNG 214 may preprocess the list of random 2D Gaussian kernels using a random flipping function or class (e.g., rand_flip). In an example, the list of random 2D Gaussian kernels may be preprocessed as:

$${g}_{d} ( {k}_{n} ) = ( \frac{{g}_{d} ( {k}_{n} )}{{\sum }_{i = 0}^{s - 1} {\sum }_{j = 0}^{s - 1} {g}_{d} ( {k}_{n} )} ) rand\_flip$$

wherein, ‘g_{d}(kₙ)’ may indicate the preprocessed list of random 2D Gaussian kernels.

After preprocessing of the list of random 2D Gaussian kernels, the RNG 214 may generate the 2D Gaussian kernels by automating sampling or normalization of the list of random 2D Gaussian kernels at each window size index ‘kₙ’ by randomly generating an ‘mₙ’ index value associated with each of the sample kernel files 216. The generated 2D Gaussian kernels may be included in the precomputed Gaussian dictionary 212. In an example, the 2D Gaussian kernels may be generated as:

G_{d}(kₙ)=[g_{d}(kₙ)]_{for m}_{ₙ}ₜᵢₘₑₛ

wherein, ‘G_{d}(kₙ)’ may indicate the precomputed Gaussian dictionary 212 including the 2D Gaussian kernels of size ‘s×s×mₙ.’

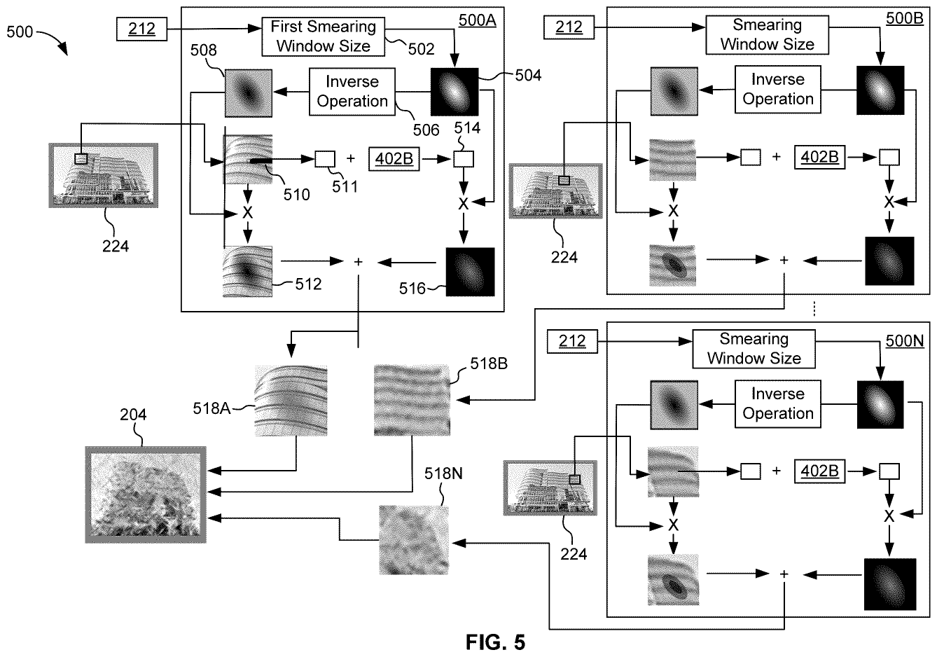

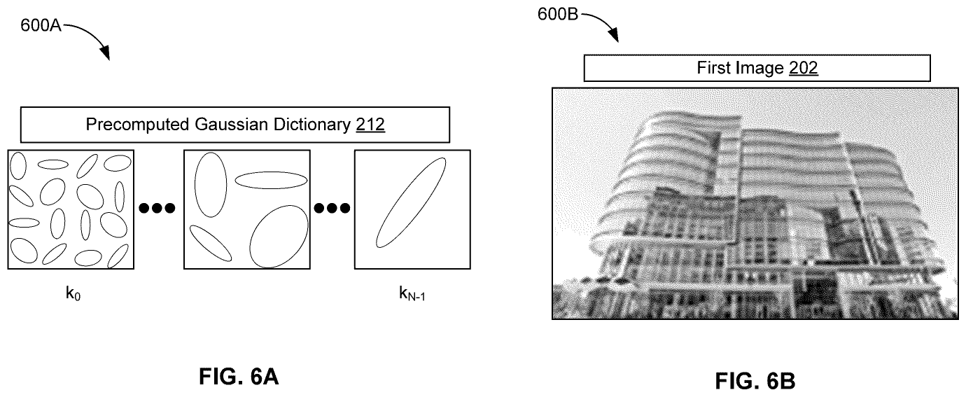

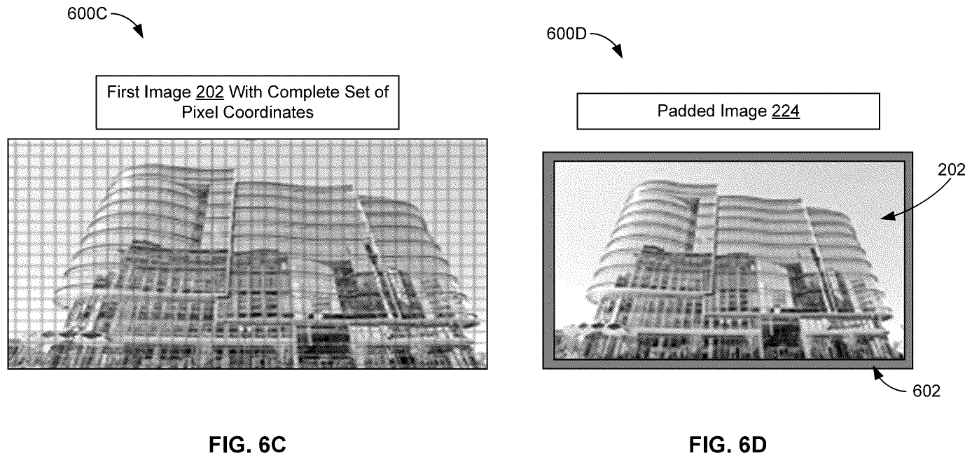

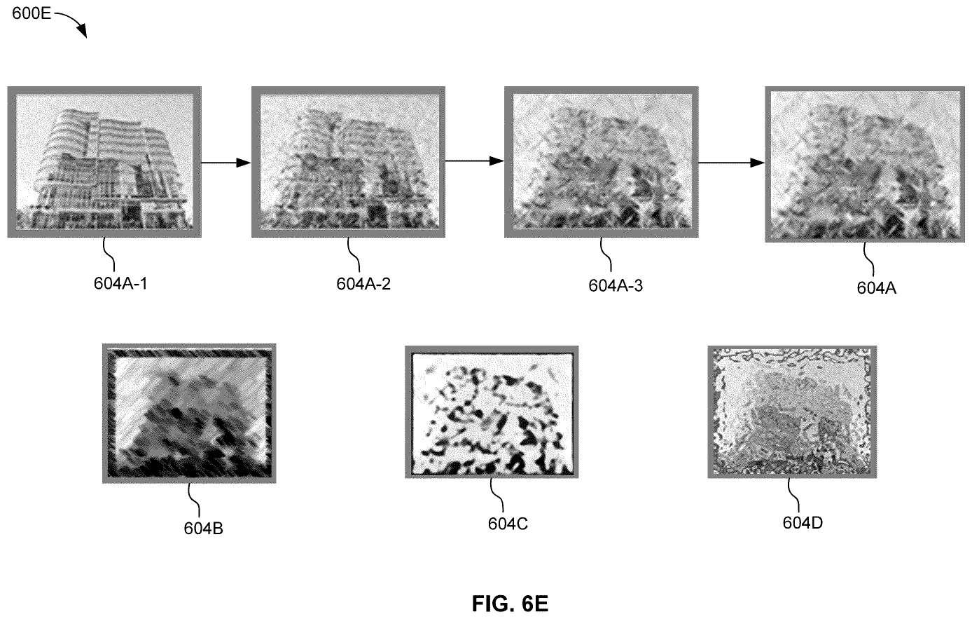

Further, the RNG 214 may store the precomputed Gaussian dictionary 212 including the 2D Gaussian kernels in the internal database 128 as kernel files. As would be understood, the RING 214 may include all the 2D Gaussian kernels in the precomputed Gaussian dictionary 212, which may enable automated querying of the 2D Gaussian kernels for generation of the splatted image 204 rather than computing the 2D Gaussian kernels at the time of generating the splatted image 204. Such a precomputation or generation of the 2D Gaussian kernels may reduce time and utilization of computing resources required for generating the splatted image 204. An example illustration 600A of the precomputed Gaussian dictionary 212 including the 2D Gaussian kernels is depicted in FIG. 6A.

The PKAG module 208 may generate a smear coordinate list 218 and a pixel quantity list 220 for the first image 202. The smear coordinate list 218 and the pixel quantity list 220 may be used by the GA IG module 210 for generating the splatted image 204.

For generating the smear coordinate list 218 and the pixel quantity list 220, the PKAG module 208 may receive the first image 202. The first image 202 may include pixels or picture elements that represent units of information. In some examples, the PKAG module 208 may receive the first image 202 from the data source 110 or from the GKDG module 206. The first image 202 may include an original image or a ground-truth image without the uncertainty artifacts. An example illustration 600B of the first image 202 and an example illustration 600C of the first image 202 with a complete set of pixel coordinates (also be referenced as pixel locations) corresponding to the pixels are depicted in FIGS. 6B and 6C, respectively.

After receiving the first image 202, the PKAG module 208 may generate a pixel coordinate list by implementing or applying a random shuffle on the complete set of the pixel coordinates of the first image 202. Therefore, the pixel coordinate list may include randomly shuffled complete set of pixel coordinates of the first image 202. In an example, the pixel coordinate list may be generated as:

pixel coordiante list=([uv₁uv₂. . . . . . uv_{P×Q}])random_shuffle

wherein, ‘uv₁ uv₂ . . . . . . uv_{P×Q}’ may indicate the complete set of pixel coordinates of the first image 202.

Based on the generated pixel coordinate list, the PKAG module 208 may generate the smear coordinate list 218. The smear coordinate list 218 may be a new coordinate list generated from the pixel coordinate list with a reduced size. The PKAG module 208 may generate the smear coordinate list 218 by selecting a subset of pixel coordinates from the pixel coordinate list based on a proportion of its length. The smear coordinate list 218 may be considered as candidate pixel coordinates or locations for generating the splatted image 204 by the GAIG module 210. In an example, the smear coordinate list 218 may be generated as:

smear coordinate list=pixel_list[0: propf×length (pixel_coordinate_list)] wherein, ‘propf×length (pixel_coordinate_list)’ may indicate the proportion of length of the pixel coordinate list and may be computed as:

propf=propₘₐₓ×RNG_{[0,1]}+propₘᵢₙ

wherein, ‘propₘₐₓ’ and ‘propₘᵢₙ’ may indicate pre-defined maximum and minimum proportion values, wherein 0≤propₘₐₓ≤(1−propₘᵢₙ) and propₘᵢₙ ∈[0, 1], and ‘RNG_{[0,1]}’ may represent values generated by the RNG 214 and the values may range from ‘0’ to ‘1’.

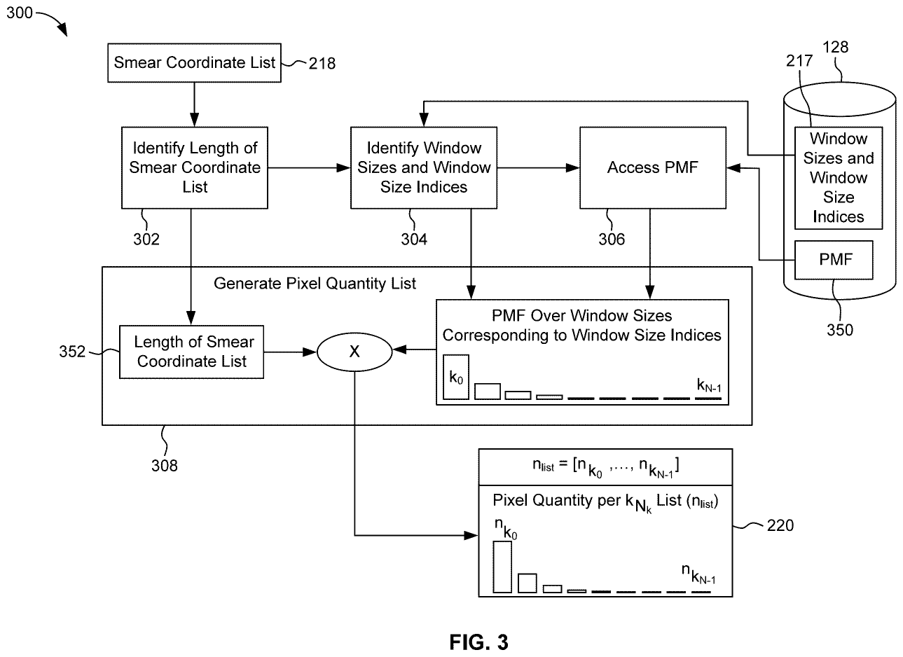

Once the smear coordinate list 218 is generated, the PKAG module 208 may generate the pixel quantity list 220 (e.g., ‘nₗᵢₛₜ’). An example process flow 300 of generating the pixel quantity list 220 is depicted in detail along with FIG. 3.

As depicted in FIG. 3, the PKAG module 208 may identify 302 a length 352 of the smear coordinate list 218. Also, the PKAG module 208 may identity 304 the number of window sizes (e.g., ‘N’) in the selected window size (e.g., ‘s×s’) and the corresponding window size indices (e.g., ‘k₀, k₁, . . . , k_{N-1}’) (e.g., the number of window sizes and the corresponding window size indices 217) by accessing the internal database 128. Further, the PKAG module 208 may access 306 a Probability Mass Function (PMF) 350 from the internal database 128. The PKAG module 208 may generate 308 the pixel quantity list 220 using the length 352 of the smear coordinate list 218, the number of window sizes and the corresponding window size indices 217, and the PMF 350. By way of non-limiting example, the PKAG module 208 may use the PMF 350 as an exponentially decaying function for generating the pixel quantity list 220. In an example, the PMF 350 as the exponentially decaying function may be represented as:

$$PMF ( {k}_{n} ) = \frac{{e}^{- {k}_{n}}}{{\sum }_{i = 0}^{N - 1} {e}^{- {k}_{i}}}$$

The PMF 350 as the exponentially decaying function may define proportions of the subset of pixel coordinates in the smear coordinate list 218, which may be smeared by each of the window sizes (‘N’) corresponding to the window size index (e.g., ‘kₙ’) to generate the pixel quantity list 220. To illustrate in detail, the PKAG module 208 may multiply the PMF 350 over a space of the window sizes (‘N’) with the length 352 of the smear coordinate list 218 to compute a quantity of candidate pixel coordinates for each of the window sizes, thereby generating the pixel quantity list 220. The pixel quantity list 220 may include a list of different quantities of the pixel coordinates corresponding to each of the window sizes. In an example, the pixel quantity list 220 (‘nₗᵢₛₜ’) may be generated as:

nₗᵢₛₜ=nₖ_{₀}, . . . . . . ,nₖ_{_{N−1}}

Generation of the pixel quantity list 220 may be used for selecting the 2D Gaussian kernels from the precomputed Gaussian dictionary 212. The selected 2D Gaussian kernels may be used by the GAIG module 210 to generate the splatted image 204. For example, based on dependance on image resolution (e.g., a length of the pixel coordinate list (length(pixel_coordinate_list))), the PMF 350, the predefined maximum proportion value (e.g., ‘propₘₐₓ’), a 2D Gaussian kernel with a maximum size may be not selected for the first image 202 with a small image resolution. To illustrate, pixel quantities for each ‘kᵢ’ listed in the pixel quantity list 220 corresponding to large window sizes may be equal to zero for small images. Therefore, generation of the pixel quantity list 220 may automatically adjust selection of the 2D Gaussian kernels based on the image resolution of the first image 202. The PKAG module 208 may store the smear coordinate list 218 and the pixel quantity list 220 in the internal database 128.

Referring back to FIG. 2, once the smear coordinate list 218 and the pixel quantity list 220 are generated, the GAIG module 210 may generate the splatted image 204 for the first image 202.

For generating the splatted image 204, the GAIG module 210 may generate a padded image 224 for the first image 202. In an example, the GAIG module 210 may generate the padded image based on a maximum size of a 2D Gaussian kernel included in the precomputed Gaussian dictionary 212. The padded image 224 may include an image where additional pixels (e.g., borders) are included around an original content of the first image 202. Therefore, the padded image 224 may have the first image 202 in a center, with an additional area included around edges of the first image 202. The additional area may be filled with a color or transparency. An example illustration 600D of the padded image 224 including the first image 202 with an additional area 602 is depicted in FIG. 6D.

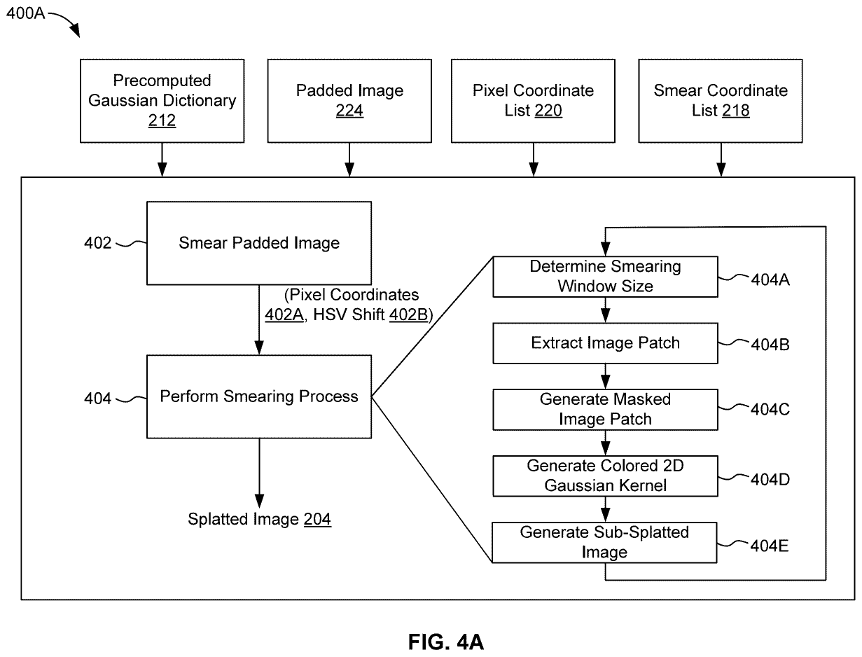

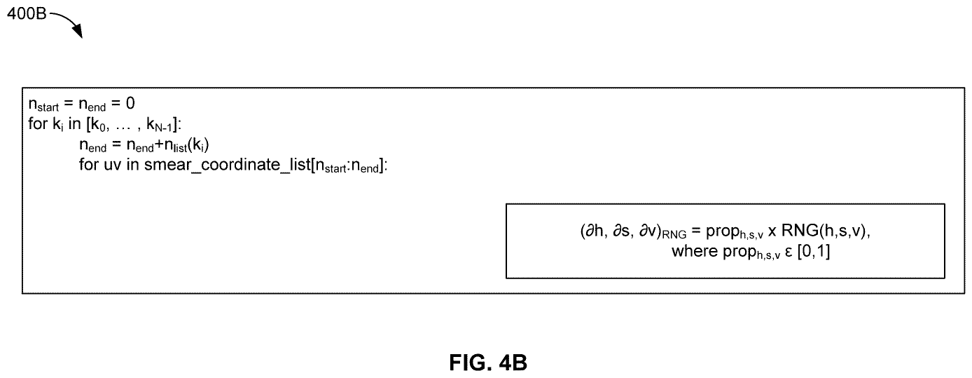

Additionally, or alternatively, the GAIG module 210 may randomly sample one or more pixel coordinates of the padded image 224. After randomly sampling the padded image 224, the GAIG module 210 may perform a smearing process to generate the splatted image 204 corresponding to the first image 202 based on the precomputed Gaussian dictionary 212, the smear coordinate list 218, the pixel quantity list 220, and the padded image 224. In an example, the GAIG module 210 may use a Gaussian Smearing Function (GSF) 226 for generating the splatted image 204. An example process flow 400A of generating the splatted image is depicted in detail along with FIG. 4A.

As depicted in FIG. 4A, the GAIG module 210 may smear 402 the padded image 224 at each pixel coordinate listed in the smear coordinate list 218 by performing a number of iterations through each window size index (‘kᵢ’) corresponding to each of the number of window sizes (‘k₀, k₁, . . . , k_{N-1}’). From the smearing of the padded image 224, a number of pixel coordinates 402A of the padded image 224 and a random hue, saturation, and value (HSV) shift 402B to be considered for generating the splatted image 204 may be identified. An example pseudo code 400B illustrating smearing of the padded image 224 at each pixel coordinate (e.g., ‘uv’) listed in the smear coordinate list 218 by performing a number of iterations through each window size index (‘kᵢ’) corresponding to each of the number of window sizes (‘k₀, k₁, . . . , k_{N-1}’) is depicted in FIG. 4B. As depicted in FIG. 4B, a value of ‘nₗᵢₛₜ [kᵢ]’ may define the number of pixel coordinates 402A to be considered in generating the splatted image 204. At each iteration, the 2D Gaussian kernels of the precomputed Gaussian dictionary 212 generated at each window size index (e.g., ‘G_{d}(kᵢ)’) may be applied on the padded image 224 and the HSV shift 402B (also be referenced as controllable severity parameter) may be computed. The HSV shift 402B may be a shift in HSV or color perturbation added to a HSV color of the given pixel location. In an example, the HSV shift 402B may be computed as:

HSV=(∂h,∂s,∂v)_{RNG}=prop_{h,s,v}×RNG(h,s,v)

wherein, RNG (h, s, v)∈[0, 1]_{3×1} may represent a random array generator of size 3×1 defining a random shift along a HSV space, and prop_{h,s,v}∈[0, 1]_{3×1} may represent as an array of size 3×1, which is a proportional constant defined to limit the largest relative shifts in the HSV that may be taken for the given pixel location.

Once the HSV shift 402B for each window size index is computed, the GSF 226 may perform 404 the smearing process in a number of smearing iterations, which may result in a generation of the splatted image 204. In an example, the GSF 226 may be represented as: GSF((∂h, ∂s, ∂v)_{RNG}, G_{d}(kᵢ), uv). In an example, the number of smearing iterations may be defined by the number of pixels of the padded image 224 that have been selected to be smeared (e.g., the length of ‘nₗᵢₛₜ’).

At each iteration, the smearing process may include (i) determining 404A a smearing window size by selecting and sampling one of the 2D Gaussian kernels in the precomputed Gaussian dictionary 212 based on the pixel quantity list 220; (ii) extracting 404B an image patch from the padded image 224, wherein a size of the image patch matches with the determined smearing window size; (iii) generating 404C a masked image patch of the padded image 224; (vi) generating 404D a colored 2D Gaussian by calculating a perturbed color for the selected 2D Gaussian kernel; and (v) generating 404E a sub-splatted image by performing a weighted sum between the masked image patch and the colored 2D Gaussian kernel. The sub-splatted image may include the masked image patch injected with one of the uncertainty artifacts. As would be understood, sub-splatted images generated during the number of smearing iterations may form the splatted image 204.

An example illustration 500 of performing the smearing process by the GSF 226 based on the HSV shift 402B and the precomputed Gaussian dictionary 212 is depicted in FIG. 5. As depicted in FIG. 5, during a first smearing iteration 500A, the GSF 226 may determine a first smearing window size 502 (also be referenced as Gaussian kernel size) by selecting a first 2D Gaussian kernel 504 from the precomputed Gaussian dictionary 212 with respect to a first window size from the number of window sizes (of the window size) selected by the RNG 214 and sampling the selected 2D Gaussian kernel at the first window size using a random index ‘mₙ.’ The random index may be generated using the RNG 214. At any iteration, the 2D Gaussian kernel may be selected by starting with the 2D Gaussian kernel with the minimum size and ending with the 2D Gaussian kernel with the maximum kernel, based on the pixel quantity list 220. For example, during the first smearing iteration 500A, the 2D Gaussian kernel with the minimum size may be selected and during a last smearing iteration, the 2D Gaussian kernel with the maximum size may be selected. Therefore, the first 2D Gaussian kernel 504 may include the 2D Gaussian kernel with the minimum size. By way of non-limiting example, at any iteration, a smearing window size may indicate an area or region of the padded image 224 on which the uncertainty artifact to be injected using the selected 2D Gaussian kernel and may be determined as:

Smearing Window Size=Gₖ[RNG(mₙ)], whereinGₖ=G_{d}(kᵢ)

Upon determining the first smearing window size 502, the GSF 226 may perform an inverse operation 506 on the first 2D Gaussian kernel 504 to generate an inversed 2D Gaussian kernel 508. Further, the GSF 226 may extract a first image patch 510 around a first pixel coordinate 511 of the padded image 224. The first pixel coordinate 511 may be from the number of pixel coordinates 402A determined from smearing of the padded image 224. A size of the first image patch 510 matches with the first smearing window size 502. At any iteration, an image patch of the padded image 224 may be represented as: patch_{clip}(uv, size(Gₖ[RNG(mₙ)). After extracting the first image patch 510, the GSF 226 may generate a first masked image patch 512 by multiplying the first image patch 510 with the inversed 2D Gaussian kernel 508. The inversed 2D Gaussian kernel 508 may govern a proportion of an image patch that contributes to a final image patch after the summation.

In parallel, the GSF 226 may compute a perturbed color 514 for the selected first 2D Gaussian kernel 504. The perturbed color 514 for the first 2D Gaussian kernel 504 may include a modified color computed using the HSV shift 402B computed for the first pixel coordinate 511 of the padded image 224. Once the perturbed color 514 is computed, the GSF 226 may generate a first colored 2D Gaussian kernel 516 by multiplying the perturbed color 514 with the first 2D Gaussian kernel 504. Further, the GSF 226 may generate a first sub-splatted image 518A by performing a weighted sum between the first masked image patch 512 and the first colored 2D Gaussian kernel 516. The first sub-splatted image 518A may include the uncertainty artifacts injected on the first image patch 510.

Similarly, at subsequent smearing iterations 500B-500N, subsequent sub-splatted images 518B-518N images may be generated. The subsequent sub-splatted images 518B-518N may include the uncertainty artifacts on subsequent image patches of the padded image 224. The first sub-splatted image 518A and the subsequent sub-splatted images 518B-518N may form the splatted image 204 corresponding to the first image 202. The splatted image 204 may include the uncertainty artifacts. It should be noted that FIG. 5 depicts an illustration of generating the splatted image 204 by injecting the uncertainty artifact on each image patch of the padded image 224 during each of the smearing iterations, however as would be understood, any other uncertainty artifacts may be injected into the entire padded image 224 during each of the smearing iterations for generating the splatted image 204.

An example illustration 600E including splatted images 604A, 604B, 604C, 604D with different uncertainty artifacts are depicted in FIG. 6E. It should be noted that each of the splatted images 604A, 604B, 604C, and 604D may be analogous to the splatted image 204. As depicted in FIG. 6E, by way of non-limiting example, a splatted image 604A may by formed by generating sub-splatted images 604A-1, 604A-2, and 604A-3 (e.g., by injecting uncertainty artifact into the entire padded image 224 during each of the smearing iterations).

With the above-described components of the artifact emulation engine 122, the smearing process may be performed with reduced computational time and reduced utilization of computing resources. In addition, the artifact emulation engine 122 acting as a data augmentation emulator may allow existing datasets for any AI task to be extended to generation and rendering of images using the 3DGS model 114, which may account for multiple levels of the uncertainty artifacts during a scene learning process. Such an extension of the existing datasets may allow for automated AI analysis at any viewpoint of a camera or trajectory within the 3DGS model 114 of the scene.

FIG. 7A depicts an example conceptual architecture 700A of the confidence validation engine 124 of the system 102 disclosed in the example environment 100 of FIG. 1, for training a confidence model 702A, in accordance with implementations of the present disclosure. The confidence validation engine 124 includes a feature vector generation module 704, a first encoder 706, a second encoder 708, an average pooling function 710, a value generation and comparison module 712, a distance value generation model 714, and an updating module 716.

The feature vector generation module 704 may receive the splatted image 204 from the internal database 128 or the artifact emulation engine 122 and provide the splatted image 204 to the first encoder 706 and the second encoder 708. The splatted image 204 may include the emulated or augmented first image 202 (an example of the first image 202 is depicted in FIG. 6B) with the uncertainty artifacts (e.g., the splatted images 604A-604D with the different uncertainty artifacts are depicted in FIG. 6D). Non-limiting examples of the first encoder 706 (also be referenced as human visual information feature encoder) and the second encoder 708 (also be referenced as non-reference image quality assessment feature encoder) may include a DreamSim encoder and Contrastive Language-Image Pre-training (CLIP)-Image Quality Assessment (IQA) encoder (CLIP-IQA encoder), respectively.

The first encoder 706 and the second encoder 708 may generate feature vectors corresponding to the splatted image 204. The generated feature vectors may be concatenated. Hereinafter, the concatenated feature vectors using the first encoder 706 and the second encoder 708 may be referenced as first feature vectors 718A. The feature vectors generated using the first encoder 706 may include feature vectors or numerical representations or non-reference image quality assessment descriptors learned from a non-referenced image quality space of the uncertainty artifacts present in the splatted image 204. The feature vectors generated using the second encoder 708 may include feature vectors or numerical representations or human visual feature descriptors learned from a human visual feature space (e.g., the actionable information) in the splatted image 204. The human visual feature space may be a feature space of learned actionable information of the scene, which may groupings of subclasses associated with the scene.

The first feature vectors 718A generated using the first encoder 706 and the second encoder 708 may be associated with high dimensionality (e.g., a large size). Therefore, the feature vector generation module 704 may enable the average pooling function 710 to convert the first feature vectors 718A into second feature vectors 718B with reduced dimensionality. It should be noted that the second feature vectors 718B may include concatenation of the feature vectors generated using the first encoder 706 and the second encoder 708, with reduced dimensionality.

Once the second feature vectors 718B are obtained, the value generation and comparison module 712 may access the confidence model 702A from the model database 108. A non-limiting example of the confidence model 702A may include a Multi-Layer Perceptron (MLP) model. As would be understood, any other suitable AI or ML or Generative AI model may be considered as the confidence model 702A. The value generation and comparison module 712 may provide the second feature vectors 718B to the confidence model 702A and train the confidence model 702A to generate a distance value 720 based on the second feature vectors 718B. Among the second feature vectors 718B, the confidence model 702A may identify the feature vectors associated with the first encoder and the feature vectors associated with the second encoder and map the identified feature vectors to generate the distance value 720. The distance value 720 may be generated by mapping the non-referenced image quality space of the uncertainty artifacts with the human visual feature space. The distance value 720 may include a non-reference human quality score and may be mapped to a single range, for example, a [0, 1] range. In some examples, the value generation and comparison module 712 may apply a sigmoid function on the distance value 720 (e.g., an output) generated by the confidence model 702A to ensure that the distance value 720 is in the range of [0, 1].

In parallel, the value generation and comparison module 712 may provide the first image 202 (e.g., the original or ground-truth image) and the splatted image 204 to the distance value generation model 714. By way of non-limiting example, the distance value generation model 714 may include a full DreamSim model. The distance value generation model 714 may generate a ground-truth distance value 722. The ground-truth distance value 722 may include a sample distance value generated by computing a distance between the first image 202 and the splatted image 204.

Further, the value generation and comparison module 712 may determine an error value 724 by comparing the distance value 720 determined using the confidence model 702A with the ground-truth distance value 722. By way of non-limiting example, the error value 724 may include a mean square error (MSE) between the distance value 720 and the ground-truth distance value 722.

Once the error value 724 is determined, the updating module 716 may iteratively retrain or fine-tune the confidence model 702A to minimize the error value 724. Minimizing the error value 724 may allow the updating module 716 for updating parameters of the confidence model 702A. In some examples, the parameters of the confidence model 702A may depend on parameters of the MLP that may include a series of matrix multiplications from the first feature vectors into the second feature vectors of reduced dimensionality. A final dimension of the confidence model 702A may be a signal value, which is then passed through the sigmoid function to map the output of the confidence model 702A (e.g., the distance value) to the range of [0, 1]. Iteratively retraining or fine-tuning the confidence model 702A through updating of the parameters may generate a trained confidence model 702B with optimized performance. The trained confidence model 702B may efficiently predict a distance value of any image including the uncertainty artifacts in a non-reference way by considering any rich image quality features and the human visual feature descriptors. Therefore, the artifact emulation engine 122 may provide a means of self-supervision for the confidence validation engine 124 to predict the distance value of any image in the presence of the uncertainty artifacts (such as uncertainty artifacts to be encountered in recovery of the actionable information in any image).

FIG. 7B depicts another example conceptual architecture 700B of the confidence validation engine 124 of the system 102 disclosed in the example environment 100 of FIG. 1, for validating recovery of the actionable information in a second image 730 using the trained confidence model 702B, in accordance with implementations of the present disclosure. The confidence validation engine 124, depicted in FIG. 7B, includes the feature vector generation module 704, the first encoder 706, the second encoder 708, the average pooling function 710, and a confidence score generation module 728.

The feature vector generation module 704 may receive the second image 730 to be validated in real-time or during the inference phase. In some examples, the second image 730 may be generated by the image generator 130 of the system 102 using the 3DGS model 114 (depicted in FIG. 1). In some other examples, the second image 730 may be received from the user device 104, the data acquisition device 106, or any other similar external devices that have been generated the second image 730 using image recovery techniques or the 3DGS model 114. The second image 730 may include the actionable information of the scene or site with the uncertainty artifacts.

The feature vector generation module 704 may provide the second image 730 to the first encoder 706 and the second encoder 708 and obtain the first feature vectors 732A corresponding to the second image 730. The first feature vectors 732A may include concatenation of feature vectors generated using the first encoder 706 and feature vectors generated using the second encoder 708 corresponding to the second image 730. The feature vectors generated using the first encoder 706 may identify the non-reference image quality assessment descriptors learned from the uncertainty artifacts present in the second image 730. The feature vectors generated using the second encoder 708 may identify the human visual feature descriptors learned from the actionable information present in the second image 730. As the first feature vectors 732A corresponding to the second image 730 are of high dimensionality, the average pooling function 710 may convert the first feature vectors 732A into second feature vectors 732B corresponding to the second image 730. The second feature vectors 732B corresponding to the second image may be of low dimensionality or reduced dimensionality.

Once the second feature vectors 732B are obtained, the confidence score generation module 728 may access the trained confidence model 702B from the model database 108. For simplicity, the trained confidence model 702B including the MLP model is depicted in FIG. 7B, however it would be obvious for a person skilled in the art any other suitable model may be identified for training and predicting distance value of any image including the uncertainty artifacts. The confidence score generation module 728 may further enable the trained confidence model 702B to generate a distance value 734 for the second image 730 based on the respective second feature vectors 732B. The distance value 734 may be generated by mapping high-level actionable information present in the second image 730 with the uncertainty artifacts present in the second image 730. The distance value may be in a range of ‘0’ to ‘1.’ For example, the distance value 734 may be high if the uncertainty artifacts present in the second image 730 are high or the distance value 734 may be low if the uncertainty artifacts present in the second image 730 are low.

Once the distance value 734 is generated, the confidence score generation module 728 may determine the confidence score 736 based on the distance value 734 generated for the second image 730 using the trained confidence model 702B. The confidence score 736 may be used for evaluating recovery of the actionable information in the second image 730 based on the uncertainty artifacts present in the second image 730. By way of non-limiting example, the confidence score generation module 728 may generate the confidence score 736 by subtracting one from the distance value 734 that is:

confidence score=1−distance value

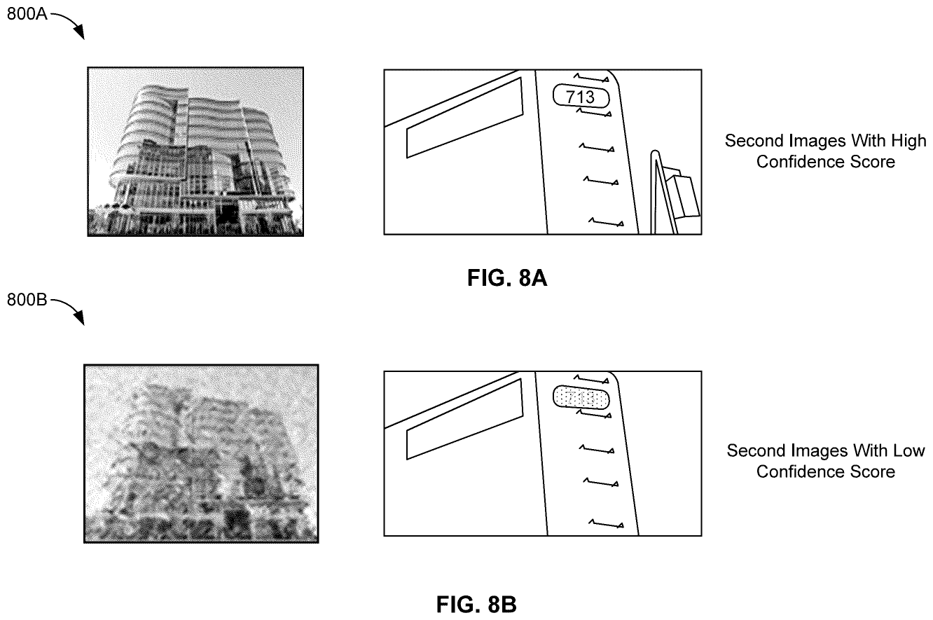

In an example, the confidence score 736 may vary in the range of [0, 1]. By way of non-limiting example, the confidence score 736 may be ‘0’, if the distance value 734 includes ‘1’, and vice-versa. Therefore, the confidence score 736 may be high, if the distance value 734 corresponding to the respective second image 730 is low or vice-versa. Further, the high confidence score may be associated with high success in recovery of the actionable information in the second image. The confidence score may be low, if the distance value 734 corresponding to the respective second image 730 is high. Further, the low confidence score may be associated with low success or failure in recovery of the actionable information in the second image. An example illustration 800A including second images, each with the high confidence score is depicted in FIG. 8A. Another example illustration 800B including second images, each with the low confidence score is depicted in FIG. 8B.

Further, the confidence score generation module 728 may provide the confidence score 736 generated for the second image 730 on a user interface of the user device 104 or the data acquisition device 106 (through the UI/UX module 126). The confidence score 736 may aid the user in deciding whether the second image 730 retains or conserves all the actionable information. Accordingly, the user may accept or reject the second image 730.

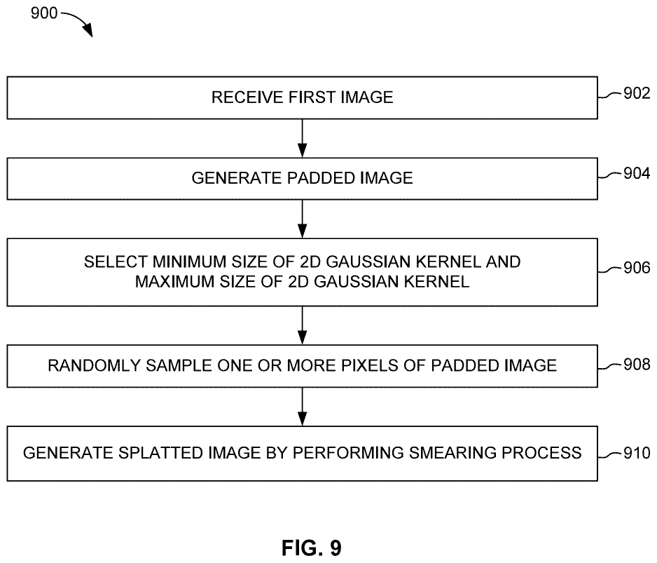

FIG. 9 is a flow diagram that presents an example computer implemented method 900 for generating the splatted image 204 corresponding to the first image 202 (depicted in FIG. 2), in accordance with implementations of the present disclosure. The splatted image 204 may be used for training of the confidence model 702A (depicted in FIG. 7A). In some implementations, the method 900 may be executed by the processor 116 (including the one or more processors) of the system 102, as described in relation to FIGS. 1-5, and 6A-6E.

The method 900 includes receiving 902 the first image 202. The first image 202 may be an original or ground-truth image of a scene or site without including any uncertainty artifacts. The first image 202 may be received from the data source 110 (depicted in FIG. 1).

In some examples, the method 900 may include generating the 2D Gaussian kernels and adding the generated 2D Gaussian kernels in the precomputed Gaussian dictionary 212 (depicted in FIG. 2). The precomputed Gaussian dictionary 212 may be used to inject the uncertainty artifacts into the first image 202. The 2D Gaussian kernels may include at least the minimum size of the 2D Gaussian kernel and the maximum size of the 2D Gaussian kernel. The 2D Gaussian kernels may be generated by selecting the window size (including the number of window sizes) and randomly sampling the window size using the RNG 214 (depicted in FIG. 2), based on the type of uncertainty artifacts to be injected into the first image 202. The window size may define an area or region over which the 2D Gaussian kernels to be evaluated. Generating the precomputed Gaussian dictionary 212 including the 2D Gaussian kernels based on the selected window sizes is described in detail in conjunction with FIG. 2, therefore repeated description is omitted herein for sake of brevity.

In some examples, the method 900 may include randomly shuffling the complete set of pixel coordinates of the first image 202 and selecting a subset of the complete set of pixel coordinates to generate a new list of pixel coordinates (e.g., the smear coordinate list 218) of a reduced size. The subset of the set of pixel coordinates may be selected based on a proportion of a length of the set of pixel coordinates of the first image 202. The method 900 further includes generating the pixel quantity list 220 by multiplying the proportion of the length of the set of pixel coordinates of the first image with the PMF 350 (depicted in FIG. 3) over a space of the number of window sizes. Generation of the smear coordinate list 218 and the pixel quantity list 220 is described in detail in FIG. 2 along with the PKAG module 208, therefore repeated description is omitted herein for sake of brevity.

The method 900 includes generating 904 the padded image 224 (depicted in FIG. 2) by padding the received first image 202. The padded image 224 may be generated according to a particular size of a 2D Gaussian kernel from the 2D Gaussian kernels included in the precomputed Gaussian dictionary 212. In some examples, the particular size is the maximum size of the 2D Gaussian kernel.

The method 900 includes selecting 906 the minimum size of the 2D Gaussian kernel and the maximum size of the 2D Gaussian kernel from the 2D Gaussian kernels included in the precomputed Gaussian dictionary 212.

The method 900 includes randomly sampling 908 one or more pixels of the padded image 224. Further, the method 900 includes smearing the padded image 224 with each pixel coordinate in the new list of pixel coordinates or smear coordinate list 218 based on the pixel quantity list 220 during each of one or more iterations. The method 900 includes computing the HSV shift 402B (depicted in FIGS. 4A and 4B) during each of the one or more iterations. Smearing of the padded image 224 and computing the HSV shift 402B are described in detail in FIGS. 2 and 4A-4B along with the GAIG module 210, therefore repeated description is omitted herein for sake of brevity.

The method 900 includes generating 910 the splatted image 204 by performing the smearing process on the padded image at the one or more randomly sampled pixels starting with the minimum size of the 2D Gaussian kernel and ending with the maximum size of the 2D Gaussian kernel. In some examples, the smearing process may be performed using the GSF 226 (depicted in FIG. 2). For performing the smearing process, the method 900 may include determining a smearing window size by selecting a 2D Gaussian kernel from the plurality of 2D Gaussian kernels starting with the minimum size of the 2D Gaussian kernel and ending with the maximum size of the 2D Gaussian kernel and the new list of pixel coordinates. Once the smearing window is determined, the method 900 may include generating an inverted 2D Gaussian kernel by applying an inverted function on the selected 2D Gaussian kernel. Further, the method 900 may include extracting an image patch from the first image and generating a masked image patch corresponding to the extracted image patch by multiplying the image patch with the selected 2D Gaussian kernel. In some examples, a size of the image patch may match with the smearing window size. The method 900 may include computing a perturbed color for the selected 2D Gaussian kernel using the HSV shift 402B and generating a colored Gaussian kernel based upon the computed perturbed color. Using the colored Gaussian kernel, the method 900 includes performing a layered 2D Gaussian splatting (e.g., performing a weighted sum between the masked image patch and the colored 2D Gaussian kernel) to generate the splatted image 204. Performing the smearing process to generate the splatted image 204 is described in detail in conjunction with FIGS. 2, 4A-4B, 5, and 6E, therefore repeated description is omitted herein for sake of description.

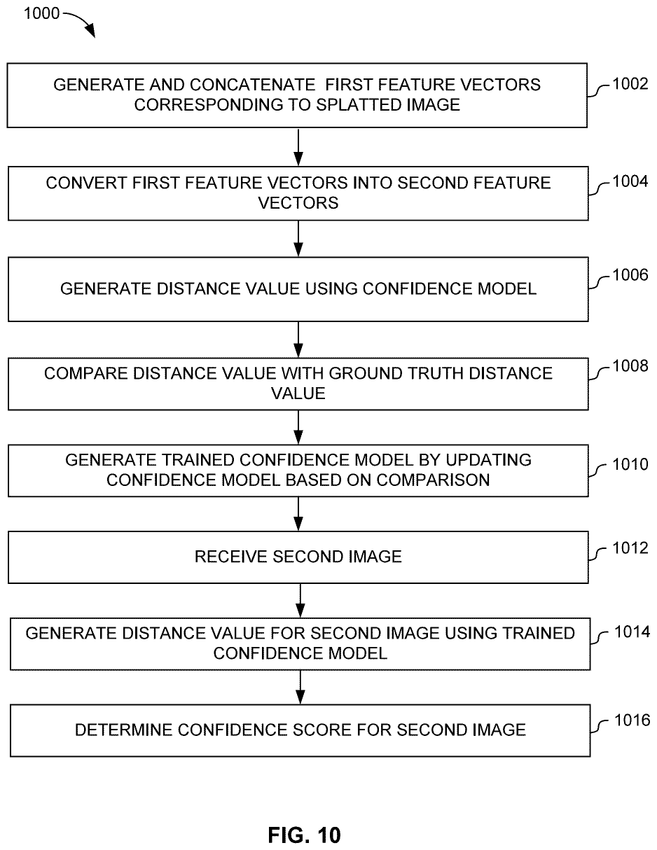

FIG. 10 is a flow diagram that presents an example computer implemented method 1000 for generating the trained confidence model 702B (depicted in FIGS. 7A and 7B) and using the trained confidence model 702B for validating recovery of the actionable information in the second image 730, in accordance with implementations of the present disclosure. In some implementations, the method 1000 may be executed by the processor 116 (including the one or more processors) of the system 102, as described in relation to FIGS. 1, 7A-7B, and 8A-8B.

The method 1000 includes generating and concatenating 1002 the first feature vectors 718A (depicted in FIG. 7A) corresponding to the splatted image 204. The first feature vectors 718A are generated by processing the splatted image using the first encoder 706 and the second encoder 708, which is described in detail in FIG. 7A, therefore repeated description is omitted herein for sake of brevity.

The method 1000 includes converting 1004 the first feature vectors into the second feature vectors 718B using the average pooling function 710 (depicted in FIG. 7A). The method 1000 includes generating 1006 the distance value 720 corresponding to the second feature vectors using the confidence model 702A. The confidence model 702A and generation of the distance value 720 are described in detail in conjunction with FIG. 7A, therefore repeated description is omitted herein for sake of brevity.

The method 1000 includes comparing 1008 the distance value 720 corresponding to the second feature vectors 718B with the ground-truth distance value 722. The ground-truth distance value 722 may be computed between a ground-truth image (e.g., the first image 202) and the splatted image 204 using the distance value generation model 714 (depicted in FIG. 7A). The method includes generating 1010 the trained confidence model 702B by updating the confidence model 702A based on the comparison, which is described in detail in FIG. 7A, therefore repeated description is omitted herein for sake of brevity.

The method 1000 includes receiving 1012 the second image 730 and generating 1014 the distance value 734 for the second image 730 using the trained confidence model 702B. The second image 730 may include the actionable information with the uncertainty artifacts. The method 1000 includes determining 1016 the confidence score 736 for the second image based on the generated distance value 734 of the second image 730. The confidence score 736 may be used to evaluate or validate recovery of the actionable information in the second image 730 in presence of the uncertainty artifacts. Steps 1012, 1014, and 1016 are described in detail in conjunction with FIG. 7B, therefore repeated description is omitted herein for sake of brevity.

Implementations of the present disclosure provide technical solutions to multiple technical problems that arise in the context of validating images generated using image recovery techniques. Implementations of the present disclosure provide an artifact emulation engine that enables generation of splatted images and provides a self-supervised mechanism for training of the confidence model using the splatted images. The splatted images may be generated by emulating or simulating first images (artifact free data) with uncertainty artifacts. In addition, the artifact emulation engine according to the present disclosure may implement selection of 2D Gaussian kernels from a precomputed Gaussian dictionary for generating the splatted images (e.g., simulated good data samples), which may result in more efficient way of generating the splatted images with reduced time and utilization of computing resources.

Implementations of the present disclosure further provide a confidence validation engine that trains the confidence model based on the splatted images and uses a trained confidence model to validate recovery of actionable information in second images including the uncertainty artifacts. During training of the confidence model (e.g., a training phase), the confidence validation engine may enable the confidence model to map a combined/concatenated feature vector composed of non-reference image quality assessment descriptors and human visual feature descriptors to predict a proximity (e.g., a distance value) of each of the splatted images to its first images (e.g., ideal or ground-truth, or artifact-free image). Such a proximity may be based on a human visual proximity measure and therefore the proximity may relate to how much scene content (e.g., the actionable information) still remains after injecting the uncertainty artifacts into the first images. The trained confidence model may exhibit an improved correlation between the predicted proximity and a ground-truth distance value determined from the splatted images and the first images. In the absence or partial lack of associated ground truth artifact-free images, the confidence validation engine may rely on the splatted images generated by the artifact emulation engine and enable the confidence model to predict the proximity between the splatted images and the first images. During an inference phase, the confidence validation engine may use the trained confidence model to validate recovery of the actionable information in second images (including the uncertainty artifacts).

Therefore, the artifact emulation engine along with the confidence validation engine may enable human visual image quality to be accessed in an automated way, which may further allow a human relevant information confidence to be automatically assigned for multiple virtual 3D scene model trajectories. The multiple virtual 3D scene model trajectories with the most information confidence may be quickly identified as well as areas with least confidence where additional image acquisition or camera views may be most needed. Further, the artifact emulation engine along with the confidence validation engine may enable regularization during 3DGS estimation to ensure problem areas are given more attention during optimization process, which may extend utilization of a 3DGS model for virtual scene exploration. Therefore, an overall value may be introduced to the virtual scene exploration application in the 3DGS model that may have emerged as the predominant 3D scene modeling framework owed to it being the fastest, less resource intensive, and most accurate at 3D scene modeling.

Further, the artifact emulation engine along with the confidence validation engine may address multiple types of uncertainty artifacts that may be extended to multiple 3D scene modeling paradigms with appropriate data emulation procedures. In addition, the artifact emulation engine along with the confidence validation engine may enable multiple high-level AI tasks that may be performed extending to 3DGS model renderings and allow AI models to be trained to be robust to existing 2D projected uncertainties. The trained AI models designed for the 3DGS model renderings may enable automated scene information (e.g., the actionable information) generation at different camera viewpoints and trajectories, further enhancing the utilization of the 3DGS scene modeling for virtual investigation.

With the above-described technical advantages, the artifact emulation engine along with the confidence validation engine may be implemented beyond recovery validation applications (e.g., validating recovery of the actionable information), for example, artifact-free image recovery, semantic segmentation, object detection, multi-label classification, and image captioning.

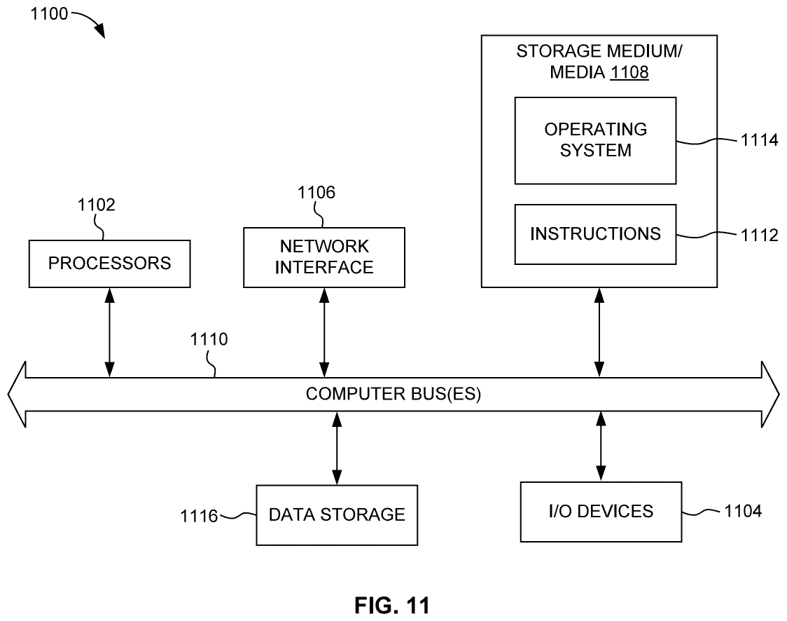

FIG. 11 depicts a computer system 1100 that may be used to implement the system 102 disclosed in the example environment of FIG. 1. M ore particularly, computing machines such as desktops, laptops, smartphones, tablets, and wearables which may be used for validating recovery of actionable information in images. The computer system 1100 may include additional components not shown and that some of the process components described may be removed and/or modified. In another example, a computer system 1100 may be deployed on external-cloud platforms such as cloud, internal corporate cloud computing clusters, organizational computing resources, and/or the like.

The computer system 1100 includes processor(s) 1102 such as, a central processing unit, ASIC or another type of processing circuit, input/output devices (I/O devices) 1104 such as, a display, mouse keyboard, etc., a network interface 1106 such as, a Local Area Network (LAN), a wireless 802.11x LAN, a 3G or 4G mobile WAN or a WiMax WAN, and a storage media or medium 1108 (also be referenced as computer-readable medium 1108 (CRM)). Each of these components may be operatively coupled to a bus 1110. The computer-readable medium 1108 may be any suitable medium that participates in providing instructions to the processor(s) 1102 for execution. For example, the computer-readable medium 1108 may be non-transitory or non-volatile medium such as, a magnetic disk or solid-state non-volatile memory or volatile medium such as RAM. The instructions or modules stored on the computer-readable medium 1108 may include machine-readable instructions 1112 executed by the processor(s) 1102 that cause the processor(s) 1102 to perform the methods and functions of the system 102.

The system 102 may be implemented as software stored on a non-transitory processor-readable medium and executed by the processor(s) 1102. For example, the computer-readable medium 1108 may store an operating system 1114 such as, MAC OS, MS WINDOWS, UNIX, or LINUX, and code, for the system 102. The operating system 1114 may be multi-user, multiprocessing, multitasking, multithreading, real-time, and the like. For example, during runtime, the operating system 1114 is running and the code for the system 102 is executed by the processor(s) 1102.

The computer system 1100 may include a data storage 1116, which may include non-volatile data storage. The data storage 1116 stores any data used or generated by the system 102.

The network interface 1106 connects the computer system 1100 to internal systems for example, via a LAN. Also, the network interface 1106 may connect the computer system 1100 to the Internet. For example, the computer system 1100 may connect to web browsers and other external applications and systems via the network interface 1106.

What has been described and illustrated herein is an example along with some of its variations. The terms, descriptions, and figures used herein are set forth by way of illustration only and are not meant as limitations. Many variations are possible within the scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an A SIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 1102 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, by one or more processors of at least one computing device, a first image;
generating, by the one or more processors, a padded image by padding the received first image, wherein the padded image is generated according to a particular size of a two-dimensional (2D) Gaussian kernel, and wherein the particular size is a maximum size of the 2D Gaussian kernel;
selecting, by the one or more processors, a minimum size of the 2D Gaussian kernel and the maximum size of the 2D Gaussian kernel;
randomly sampling, by the one or more processors, one or more pixels of the padded image; and
generating, by the one or more processors, a splatted image by performing a smearing process on the padded image at the one or more randomly sampled pixels starting with the minimum size of the 2D Gaussian kernel and ending with the maximum size of the 2D Gaussian kernel.

2. The computer-implemented method of claim 1, further comprising:
generating and concatenating, by the one or more processors, first feature vectors corresponding to the splatted image, wherein the first feature vectors are generated by processing the splatted image using a first encoder and a second encoder;
converting, by the one or more processors, the first feature vectors into second feature vectors using an average pooling function;
generating, by the one or more processors, a distance value corresponding to the second feature vectors using a confidence model;
comparing, by the one or more processors, the distance value corresponding to the second feature vectors with a ground-truth distance value, wherein the ground-truth distance value is computed between a ground-truth image and the splatted image using a distance value generation model; and
generating, by the one or more processors, a trained confidence model by updating the confidence model based on the comparison.

3. The computer-implemented method of claim 2, further comprising:
receiving, by the one or more processors, a second image, wherein the second image includes actionable information and one or more uncertainty artifacts;
generating, by the one or more processors, a distance value for the second image using the trained confidence model, wherein the distance value depends on the one or more uncertainty artifacts present in the second image; and
determining, by the one or more processors, a confidence score for the second image based on the generated distance value for the second image, wherein the confidence score is used to evaluate recovery of the actionable information in the second image in presence of the one or more uncertainty artifacts.

4. The computer-implemented method of claim 1, further comprising:
generating, by the one or more processors, a plurality of 2D Gaussian kernels including at least the minimum size of the 2D Gaussian kernel and the maximum size of the 2D Gaussian kernel, wherein the plurality of 2D Gaussian kernels is generated corresponding to a window size.

5. The computer-implemented method of claim 4, wherein the window size is randomly selected using a random number generator.

6. The computer-implemented method of claim 1, further comprising:
randomly shuffling, by the one or more processors, a set of pixel coordinates of the first image;
selecting, by the one or more processors, a subset of the set of pixel coordinates to generate a new list of pixel coordinates of a reduced size, wherein the subset of the set of pixel coordinates is selected based upon a proportion of a length of the set of pixel coordinates of the first image; and
generating, by the one or more processors, a pixel quantity list by multiplying the proportion of the length of the set of pixel coordinates of the first image with a probability mass function (PMF) over a space of a number of window sizes.

7. The computer-implemented method of claim 6, further comprising:
smearing, by the one or more processors, the padded image with each pixel coordinate in the new list of pixel coordinates based on the pixel quantity list during each of one or more iterations; and
computing, by the one or more processors, a random hue, saturation, and value (HSV) shift during each of the one or more iterations.

8. The computer-implemented method of claim 1, wherein the smearing process comprises:
determining, by the one or more processors, a smearing window size by selecting a 2D Gaussian kernel from a plurality of 2D Gaussian kernels starting with the minimum size of the 2D Gaussian kernel and ending with the maximum size of the 2D Gaussian kernel and a new list of pixel coordinates;
generating, by the one or more processors, an inverted 2D Gaussian kernel by applying an inverted function on the selected 2D Gaussian kernel;
extracting, by the one or more processors, an image patch from the first image, wherein a size of the image patch matches with the smearing window size;
generating, by the one or more processors, a masked image patch using the extracted image patch and the inverted 2D Gaussian kernel;
computing, by the one or more processors, a perturbed color for the selected 2D Gaussian kernel by using a random hue, saturation, and value (HSV) function;
generating, by the one or more processors, based upon the computed perturbed color, a colored Gaussian kernel; and
performing, by the one or more processors, using the colored Gaussian kernel, layered 2D Gaussian splatting to generate the splatted image.

9. The computer-implemented method of claim 8, wherein the smearing process is performed using a Gaussian Smearing Function (GSF).

10. A system comprising:
at least one memory comprising machine-executable instructions; and
at least one processor communicatively coupled with the at least one memory, and configured to execute the machine-executable instructions to perform operations comprising:
receiving a first image;
generating a padded image by padding the received first image, wherein the padded image is generated according to a particular size of a two-dimensional (2D) Gaussian kernel, and wherein the particular size is a maximum size of the 2D Gaussian kernel;
selecting a minimum size of the 2D Gaussian kernel and the maximum size of the 2D Gaussian kernel;
randomly sampling one or more pixels of the padded image; and
generating a splatted image by performing a smearing process on the padded image at the one or more randomly sampled pixels starting with the minimum size of the 2D Gaussian kernel and ending with the maximum size of the 2D Gaussian kernel.

11. The system of claim 10, wherein the operations further comprise:
generating and concatenating first feature vectors corresponding to the splatted image, wherein the first feature vectors are generated by processing the splatted image using a first encoder and a second encoder;
converting the first feature vectors into second feature vectors using an average pooling function;
generating a distance value corresponding to the second feature vectors using a confidence model;
comparing the distance value corresponding to the second feature vectors with a ground-truth distance value, wherein the ground-truth distance value is computed between a ground-truth image and the splatted image using a distance value generation model; and
generating a trained confidence model by updating the confidence model based on the comparison.

12. The system of claim 11, wherein the operations further comprise:
receiving a second image, wherein the second image includes actionable information and one or more uncertainty artifacts;
generating a distance value for the second image using the trained confidence model, wherein the distance value depends on the one or more uncertainty artifacts present in the second image; and
determining a confidence score for the second image based on the generated distance value for the second image, wherein the confidence score is used to evaluate recovery of the actionable information in the second image in presence of the one or more uncertainty artifacts.

13. The system of claim 10, wherein the operations further comprise:
generating a plurality of 2D Gaussian kernels including at least the minimum size of the 2D Gaussian kernel and the maximum size of the 2D Gaussian kernel, wherein the plurality of 2D Gaussian kernels is generated corresponding to a kernel level or a window size.

14. The system of claim 13, wherein the kernel level or the window size is randomly selected using a random number generator.

15. The system of claim 10, wherein the operations further comprise:
randomly shuffling a set of pixel coordinates of the first image;
selecting a subset of the set of pixel coordinates to generate a new list of pixel coordinates of a reduced size, wherein the subset of the set of pixel coordinates is selected based upon a proportion of a length of the first image; and
generating a pixel quantity list by multiplying the proportion of the length of the first image with a probability mass function (PMF) over a space of a number of window sizes.

16. The system of claim 15, wherein the operations further comprise:
smearing the padded image with each pixel coordinate in the new list of pixel coordinates based on the pixel quantity list during each of one or more iterations; and
computing a random hue, saturation, and value (HSV) shift during each of the one or more iterations.

17. The system of claim 10, wherein the smearing process comprises:
determining, by the one or more processors, a smearing window size by selecting a 2D Gaussian kernel from a plurality of 2D Gaussian kernels starting with the minimum size of the 2D Gaussian kernel and ending with the maximum size of the 2D Gaussian kernel and a new list of pixel coordinates;
generating, by the one or more processors, an inverted 2D Gaussian kernel by applying an inverted function on the selected 2D Gaussian kernel;
extracting, by the one or more processors, an image patch from the first image, wherein a size of the image patch matches with the smearing window size;
generating, by the one or more processors, a masked image patch using the extracted image patch and the inverted 2D Gaussian kernel;
computing, by the one or more processors, a perturbed color for the selected 2D Gaussian kernel by using a random hue, saturation, and value (HSV) function;
generating, by the one or more processors, based upon the computed perturbed color, a colored Gaussian kernel; and
performing, by the one or more processors, using the colored Gaussian kernel, layered 2D Gaussian splatting to generate the splatted image.

18. The system of claim 17, wherein the smearing process is performed using a Gaussian smearing function.

19. At least one non-transitory computer-readable media (CRM) comprising machine-executable instructions stored thereon, which when executed by at least one processor of a computing system cause the computing system to perform operations comprising:
receiving a first image;
generating a padded image by padding the received first image, wherein the padded image is generated according to a particular size of a two-dimensional (2D) Gaussian kernel, and wherein the particular size is a maximum size of the 2D Gaussian kernel;
selecting a minimum size of the 2D Gaussian kernel and the maximum size of the 2D Gaussian kernel;
randomly sampling one or more pixels of the padded image; and
generating a splatted image by performing a smearing process on the padded image at the one or more randomly sampled pixels starting with the minimum size of the 2D Gaussian kernel and ending with the maximum size of the 2D Gaussian kernel.

20. The at least one non-transitory CRM of claim 19, wherein the smearing process comprises:
determining, by the one or more processors, a smearing window size by selecting a 2D Gaussian kernel from a plurality of 2D Gaussian kernels starting with the minimum size of the 2D Gaussian kernel and ending with the maximum size of the 2D Gaussian kernel and a new list of pixel coordinates;
generating, by the one or more processors, an inverted 2D Gaussian kernel by applying an inverted function on the selected 2D Gaussian kernel;
extracting, by the one or more processors, an image patch from the first image, wherein a size of the image patch matches with the smearing window size;
generating, by the one or more processors, a masked image patch using the extracted image patch and the inverted 2D Gaussian kernel;
computing, by the one or more processors, a perturbed color for the selected 2D Gaussian kernel by using a random hue, saturation, and value (HSV) function;
generating, by the one or more processors, based upon the computed perturbed color, a colored Gaussian kernel; and
performing, by the one or more processors, using the colored Gaussian kernel, layered 2D Gaussian splatting to generate the splatted image.
